(19) United States
(12) Patent Application Publication
(10) Pub. No.: US 2011/0135085 A1
(43) Pub. Date: Jun. 9, 2011

(54) Adaptive phone for users with intellectual impairment

(76) Inventor: Tippure S. Sundresh, Naperville, IL (US)

(21) Appl. No.: 12/592,793

(22) Filed: Dec. 3, 2009

(51) Int. Cl. H04M 3/42

(52) U.S. Cl. 379/211.02

(57) ABSTRACT

Exemplary methods and apparatuses are provided for assisting a subscriber, e.g., a subscriber with cognitive limitations, in making decisions concerning contacting a called party. In response to a subscriber's request to speak to the called party, a cognitive processor queries a database to retrieve records stored in a profile which relates the called party to rules for contact of the called party. Upon receiving the records, the cognitive processor determines a requested telephone number and one or more alternative contact telephone numbers having a high likelihood of satisfying the request. The telephone numbers are prioritized based on stored rules or calling history and a prioritized list is presented to the subscriber. The subscriber may select the telephone number of the person best qualified to satisfy the subscriber's objective. The cognitive processor generates a signal for the network to connect the subscriber to a final called party determined for the subscriber.

### TECHNICAL FIELD

This invention relates to the art of telecommunication systems, and more particularly to telecommunication systems which respond to service requests using behavior models and cognitive processing.

### BACKGROUND

The care of an aging population is a national priority in the United States. According to the United States Census Bureau there will be an estimated 40 million Americans above the age of 65 years old in 2010 and approximately 5.2 million Americans with Alzheimer's disease in 2010. Less than five percent of all older persons in the United States live in institutionalized settings while thirty percent of all non-institutionalized older persons in the United States live alone. The aging population and increasing complexities of modern living point to an increasing incidence of senior citizens requiring help with their cognitive limitations, e.g., memory loss, etc. While there is a growing trend of people requiring such help, most health care programs by and large address the medical rather than the cognitive and psychiatric side of care and assistance. In addition, persons of any age can suffer from limited cognitive processes which make dealing with modern conveniences difficult.

### SUMMARY

Apparatuses and methods are provided for communication assistance to people of all ages with cognitive limitations and/or behavior issues. Embodiments are provided that may assist users with cognitive disabilities and varying degrees of impairment to fulfill their communication needs in a simple manner compatible with their capabilities. For example, subscribers who utilize an embodiment of the disclosed apparatuses or methods may be able to remain independent and/or stay in their current living arrangement, i.e., home, for longer periods of time.

More specifically, in one embodiment of the invention, provided is a method that includes receiving at a network device a request from a subscriber to connect to a called party; generating at the network device, in response to the request, a first query to a first database to retrieve at least one record of the subscriber, the at least one record stored in a profile which relates the called party to rules for contact of the called party; and transmitting at least one signal to facilitate a connection of the subscriber to a final called party determined for the subscriber.

In another embodiment, an apparatus includes means for receiving at a network device a request from a subscriber to connect to a called party; means for generating at the network device, in response to the request, a first query to a first database to retrieve at least one record of the subscriber, the at least one record stored in a profile which relates the called party to rules for contact of the called party; and means for transmitting at least one signal to facilitate a connection of the subscriber to a final called party determined for the subscriber.

In another embodiment, a computer-readable storage medium includes means for receiving at a network device a request from a subscriber to connect to a called party; means for generating at the network device, in response to the request, a first query to a first database to retrieve at least one record of the subscriber, the at least one record stored in a profile which relates the called party to rules for contact of the called party; and means for transmitting at least one signal to facilitate a connection of the subscriber to a final called party determined for the subscriber.

In another embodiment, an apparatus includes a processor; and a storage device connected to the processor, the storage device being operable to store at least one record for parties callable by the mobile communications device, the records stored in a profile which relates a callable party to corresponding rules for contact of the callable party; wherein the processor is operable to retrieve, upon receipt of a request to communicate with a first party, a telephone number for one or more callable parties from the storage device by determining whether a match exists in a first record for a name, an image or an identifier in the request and determining one or more alternative telephone numbers that satisfy the request based on the corresponding rules for contact of the first party.

In another embodiment, a method includes receiving a request to communicate with a first party; retrieving, a telephone number for a callable party stored in the mobile communications device by matching a name, an image or an identifier in the request to a record associated with the callable party; determining one or more alternative callable parties that satisfy the request based on contact rules associated with the callable party; and providing a prioritized list of the called party and the one or more alternative callable parties on the mobile communications device.

### DESCRIPTION OF THE DRAWINGS

Some embodiments of apparatuses and methods in accordance with embodiments of the present invention are now described, by way of example only, and with reference to the accompanying drawings, in which:

FIG. 1 shows an illustrative embodiment of an exemplary adaptive phone architecture for users with intellectual disabilities arranged in accordance with the principles of the invention;

FIG. 2 shows an illustrative embodiment for an exemplary subscriber profile arranged in accordance with the principles of the invention;

FIG. 3 shows an illustrative flow chart for an exemplary method of operating an embodiment of the invention arranged in accordance with the principles of the invention; and

FIG. 4 shows an illustrative embodiment for a mobile communications device arranged in accordance with the principles of the invention.

### DETAILED DESCRIPTION

Embodiments are provided that are usable to assist users with cognitive disabilities and varying degrees of impairment to fulfill their communication needs in a simple manner compatible with their capabilities. The provided technology is adaptable to the user's limitations and augments the user's capabilities with machine intelligence, a user profile model that understands the user's limitations, and an information database maintained by the system. The technology is aimed at being an “understanding companion” to assist users, for example, those with dementia or other cognitive disabilities, in communicating effectively with the outside world.

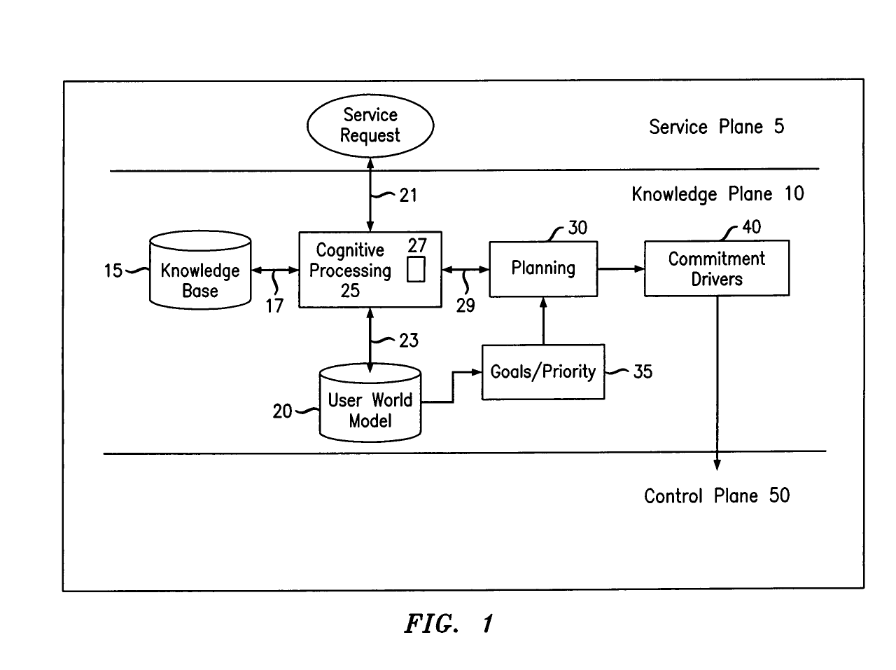

FIG. 1 shows an illustrative embodiment of an exemplary adaptive phone architecture for users with intellectual disabilities arranged in accordance with the principles of the invention. As shown in FIG. 1, architecture 100 comprises Service Plane 5 which connects to Knowledge Plane 10 which connects to Control Plane 50.

In one embodiment, Service Plane 5 contains communication devices used by service subscribers to initiate communications with networks, e.g., servers, and other subscribers and the data transmitted by the subscribers. The communication devices may include landline telephones, IP capable terminals and personal computers, not shown, which interact with a communications network via one or more of a variety of terrestrial-based access technologies, not shown, that include copper wire, fiber optics, Ethernet, and Voice over Internet Protocol (VoIP). Also, the communication devices may include mobile phones, smartphones, laptop computers, personal digital assistance (PDA) devices, portable media players, or other suitable handheld communications devices, not shown, capable of wirelessly connecting to a communications network via one or more of different types of air interfaces, not shown, that include Universal Mobile Telecommunications System (UMTS), Code Division Multiple Access (CDMA), Wireless Fidelity (Wi-Fi) and Worldwide Interoperability for Microwave Access (Wi-Max) networks. The communication devices may be capable of sending and receiving voice calls, email, short message service (SMS), images, microbrowser messages, text messaging or any combination thereof. Also, the communications devices may load Internet web pages and transfer files with servers.

Each communications device is preferably assigned a directory number. The term “directory number” is used herein in a manner consistent with its generally understood meaning of a number that is dialed or input by a call originator to reach a terminating point associated with the directory number. A directory number, typically a seven or ten digit number, is commonly referred to as a “telephone number” and may be associated with a specific telephone line or a specific communications device. A subscriber may enter the telephone number or other instructions into the communications devices by pushing the buttons of a keypad or by voice activation using a microphone or by touching a screen/image. These communication devices are well known in the art, and will not be described in detail.

Control Plane 50 performs communication session set up and tear down, contains the network infrastructure used to convey calls or messages from the call originator to the terminating point, and controls how connections are made from the call originator to the terminating point. Control Plane 50 is composed of interconnected network infrastructure, not shown, that includes a) signaling components, e.g., signaling system 7 (SS7) architecture, Transmission Control Protocol/Internet Protocol (TCP/IP), session initiation protocol (SIP), etc., b) transport components, e.g., fiber, copper, SONET systems, etc., c) switching components capable of routing calls between endpoints, e.g., circuit switches, packet switches, servers, routers, wireless switches, satellites, base stations, etc., d) storage components, e.g., databases, used to process service requests, store messages and route calls, as well as e) systems used to manage elements of Control Plane 50 and to collect call details, e.g., billing systems, and f) equipment/services used to interact with callers during a call, e.g., announcements, interactive voice response systems, etc, as will be appreciated by those of ordinary skill in the art. The functions of the network infrastructure are well known in the art, and will not be described in detail.

Knowledge Plane 10 is shown as a new service infrastructure positioned between Service Plane 5 and Control Plane 50 in FIG. 1. Knowledge Plane 10 provides intelligence and knowledge assets, e.g., data, algorithms, processors, etc., that may assist subscribers in making customized decisions concerning a called party based on rules of contact associated with the subscriber's cognitive limitations, e.g., dementia, memory loss, Alzheimer's disease, or Parkinson disease. In this exemplary embodiment, each subscriber in Service Plane 5 that desires to use the services of Knowledge Plane 10 must have a cognitive assistance feature account with a Service Provider prior to use of the services of Knowledge Plane 10. Illustratively, in one embodiment, a Service Provider may offer the cognitive assistance feature on a monthly subscription basis. In another embodiment, a Service Provider may offer the cognitive assistance feature on a fee per use basis. After activating an account, an off-hook condition, i.e., an active state of a communications link, originating from a subscriber using a telephone associated with the subscriber, e.g., a landline telephone or a mobile telephone, may be recognized and authenticated by elements of Service Plane 5 and/or elements of Control Plane 50, e.g., a switch, based on the originating telephone number as an identifier, and automatically connected to the services of Knowledge Plane 10. In other words, the subscriber does not have to dial a telephone number to initiate a call.

When a communication device non-fixedly associated with a subscriber is utilized, additional information is necessary to identify that a subscriber wishes to utilize the services of the Knowledge Plane. For example, when a personal computer is used by a subscriber having a cognitive assistance feature account to connect to the services of Knowledge Plane 10, the personal computer may be configured with an application that sends the identifier of the subscriber to Service Plane 5 in addition to a second identifier of the device being used. As another example, the telephone of a non-disabled telephone subscriber may be used to call a social services telephone number and a subscriber identification number input, e.g., subscriber wears wristband with 1-888-Cognitive Service Number and subscriber ID No., to enable an intellectually disabled subscriber to access the Adaptive Phone Service described herein. Connection to Knowledge Plane 10 with a service request initiates processing in Knowledge Plane 10 that ultimately results in commitment drivers sending control signals to Control Plane 50. These control signals may trigger the set up and/or tear down of any subscribed service, including voice, data, text, alarms, etc.

The various elements depicted in Knowledge Plane 10 may be implemented using any combination of hardware, software, or firmware using known techniques in accordance with the teachings herein. Also, the various elements illustrate an exemplary configuration and partition of functions. An exemplary component of Knowledge Plane 10 employs and/or comprises a set and/or series of computer instructions written in or implemented with any of a number of programming languages, as will be appreciated by those skilled in the art.

As shown in FIG. 1, according to one embodiment, Knowledge Plane 10 contains Cognitive Processing Component 25 which receives service requests from subscribers in Service Plane 5 and inputs from Knowledge Base 15 and inputs from User World Model 20. Cognitive Processing Component 25 provides outputs to Planning Component 30. Planning Component 30 prioritizes the input from Cognitive Processing Component 25 with data from Goals/Priority Component 35, and provides an output to Commitment Drivers Component 40. Commitment Drivers Component 40 interfaces to Control Plane 50.

Knowledge Base 15 may be a condensed storage unit as well as a portal to relevant external world information, such as contained in an electronic Yellow or White Pages, the Internet, and other relevant databases. Knowledge Base 15 automates data retrieval and provides value to a service that may be beyond the speed and knowledge of a human assistant. Knowledge Base 15 interfaces with the outside world for updates of existing data and feedback on changes that may have taken place since a previous information retrieval. Knowledge Base 15 may be connected to a communication port to interface with any remote instructional database or telemedicine database.

User World Model 20 is a cognitive reference database that stores and manages subscriber profiles, and describes the extent of the material world surrounding the subscriber. Each subscriber profile models the behavior of the subscriber and includes requirements, limitations, interests, and priorities of the subscriber taking into consideration the extent at which the subscriber understands and can make decisions. More specifically, the subscriber profile contains information about the subscriber that may include:
1. Relationships—family members, friends, a religious guide/leader, and acquaintances and how they relate to the subscriber's environment, e.g., co-worker, neighbor, child, etc.;
2. Professional services—doctors, nurses, dentists, lawyers, home repair personnel, delivery companies, etc., and how they relate to the subscriber's environment, e.g., monthly medical appointments with Dr. Brown, bi-weekly delivery of food from Foodz Store, etc.;
3. Social outlets—places of worship, favorite restaurants or meals, movie theaters and other connections, their service capabilities, trustworthiness, availabilities, etc., and how they relate to the subscriber's environment, e.g., dinner once a week at a favorite restaurant; and
4. Contact modes—text, e-mail, voice calls, pictures and other contextual information based on the subscriber's cognitive limitations, e.g., dementia, Downs Syndrome, and other intellectual disabilities.

In one embodiment, key elements of the architecture 100 of FIG. 1 are self-contained within a mobile communications device, e.g., a cellular telephone. That is, a communications device capable of wirelessly connecting to a communications network via one or more of different types of air interfaces includes Service Plane 5 and Knowledge Plane 10. Service Plane comprises a user interface to receive input from the subscriber. For example, the user interface may be a microphone to receive sound, a keyboard or a display for obtaining an indication of a called party. Knowledge Plane 10 includes the components and databases for determining alternative calling parties or denial of service based on the requested called party. Control Plane 50 performs communication session set up and tear down in order to convey calls or messages from the communication device to a finalized called party as selected by the user of the communication device from a plurality of alternative called parties or otherwise determined by the communication device based on rules of contact, prioritization of called parties, etc. It should again be noted that Knowledge Base 15 may be a condensed storage unit as well as a portal via the Control Plane to relevant external world information, such as the electronic White or Yellow Pages, the Internet, and other relevant databases.

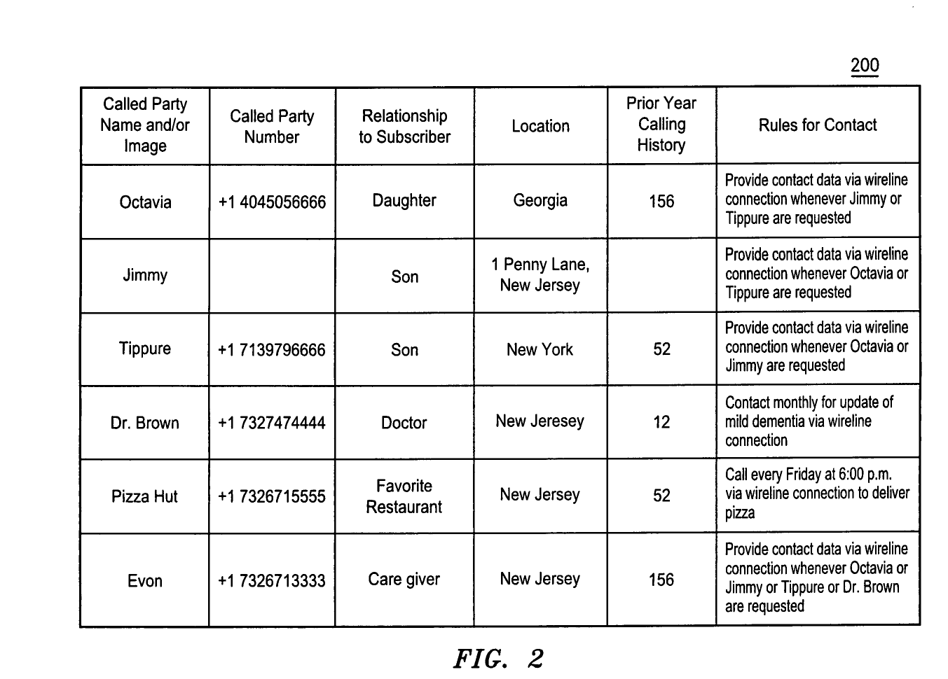

FIG. 2 shows an illustrative embodiment for an exemplary subscriber profile arranged in accordance with the principles of the invention. The structure of Profile 200 may vary depending on a particular implementation of the profile. Each row of Profile 200 represents a stored record for a particular called party. Each column of Profile 200 represents a specific attribute of each record. Profile 200 is not limited to a specific number of columns or a specific number of rows. More or less data may be provided as needed and/or desired.

As illustrated in FIG. 2, a first column of Profile 200 may provide a name and/or image of a called party, e.g., a person or a destination. The name/image of the called party may be the name/image of a business or the name/image of an individual. The length of the name may be limited to a predetermined size.

A second column of Profile 200 may provide a telephone number of the called party.

A third column of Profile 200 may provide a relationship of the called party to the subscriber.

A fourth column of Profile 200 may provide a location of the called party.

A fifth column of Profile 200 may provide a prior year calling history of the subscriber and the called party. Illustratively, the subscriber called his daughter, Octavia, 156 times in the prior year or 3 times per week on average, while calling a son, Tippure, 52 times or once per week on average.

A sixth column of Profile 200 may provide rules or conditions for contacting the subscriber and/or each person or destination, in the “Called Party Name” column. For example, the rules may indicate that a particular destination is to be contacted each week at a particular time. In addition, the rules may define alternative telephone numbers to offer a subscriber upon a service request, specific dates and times for calling a particular called party and the contact mode for connecting with the subscriber.

In one embodiment, the subscriber's profile may be accessed through use of an identifier such as the subscriber's telephone number. A specific record in the subscriber's profile may be accessed through use of an indicator. For example, the indicator may be a verbally spoken name or selection of an image of a called person or destination. Each record may be linked to other records in the subscriber's profile based on their relationship to the subscriber, e.g., family, friends, doctors, etc., their geographical location, or other informational, factual data The subscriber records used to populate the subscriber's profile may be supplied based on a historical performance of the subscriber. The records may be updated as the subscriber's cognitive limitations change, e.g., become worse, or as relationships change, e.g., a death of a friend. Updates to the records may be made based on input provided by the subscriber or input provided by a care giver of the subscriber. Elements of Control Plane 50 may provide an update on the calling history of the subscriber in one embodiment.

User World Model 20 may be stored local to the subscriber's communication device, e.g., a mobile handset, or remote therefrom. Knowledge Base 15 and User World Model 20 may be embodied as object oriented databases or any other format that may be suitable for the necessary knowledge retrieval, such as relational databases.

Again referring to FIG. 1, Cognitive Processing Component 25 receives service requests from a subscriber, for example, a subscriber with cognitive limitations, and analyzes data from User World Model 20 and Knowledge Base 15 to determine one or more possible ways to respond to the service requests. The service request from the subscriber may have an indicator (e.g., a verbally spoken name or an indication of a selected image) of a person or a destination. In other embodiments, the request may be received as a voice call, an e-mail message, an instant message, a text message, an image and other contextual information.

Cognitive Processing Component 25 has communication interfaces for sending and receiving messages, and may have one or more processors, e.g., processor 27, capable of manipulating data and controlling the operation of Cognitive Processing Component 25. Processor 27 recognizes the indicator of the person or the destination in the received message, e.g., voice call, e-mail message, etc., translates received messages to form query messages and executes program logic for sending the query messages to User World Model 20 and Knowledge Base 15. The functions of processor 27 may be provided by a single dedicated processor, by a single shared processor, or by a plurality of individual processors, some of which may be shared.

For purposes of illustration and example, Cognitive Processing Component 25 may receive a voice call via link 21 from a subscriber with dementia living in New Jersey requesting to speak to a daughter, e.g., Octavia, who, incidentally, lives in Georgia as shown in row 1 in FIG. 2. Cognitive Processing Component 25 may have speech recognition software to recognize the name “Octavia” as spoken by the subscriber. Cognitive Processing Component 25 sends a query message to User World Model 20 via link 23 using the subscriber's telephone number, e.g., an E.164 number such as +1 7326712222, as an identifier of the subscriber's profile. In another embodiment, Cognitive Processing Component 25 sends a query message to User World Model 20 via link 23 using the identifier and the name “Octavia” as an indicator of the specific record. User World Model 20 receives the query message from Cognitive Processing Component 25 via link 23. User World Model 20 accesses the subscriber's profile using the subscriber's telephone number as the identifier and sends the retrieved information which may include all the data pertaining to the particular subscriber to Cognitive Processing Component 25 via link 23.

Upon receiving the message from User World Model 20, Cognitive Processing Component 25 retrieves the record with the requested telephone number using the recognized name of the daughter, e.g., Octavia, as the indicator of the specific record. In another embodiment, Cognitive Processing Component 25 may retrieve the record that has the requested telephone number by matching an image received in the service request to an image of the daughter in the records received from User World Model 20. Also, Cognitive Processing Component 25 determines alternative contacts with a high likelihood of satisfying the subscriber's desired purpose, e.g., a telephone number for a son living in New York and a name and address for a son living in New Jersey, not mentioned by the subscriber. Cognitive Processing Component 25 may select the records of the other children based on stored rules (e.g., select other children when a child is requested) or the subscriber's previous calling history.

Next, according to the illustrative embodiment, Cognitive Processing Component 25 sends a query message to Knowledge Base 15 via link 17 requesting a telephone number based on the name and address for the son living in New Jersey, indicated in FIG. 2. Knowledge Base 15 receives the query message from Cognitive Processing Component 25 via link 17. Knowledge Base 15 may access an external database, e.g., an electronic White Pages database, to obtain the telephone number of the son living in New Jersey. Upon receiving the telephone number from the electronic White Pages database, Knowledge Base 15 responds to Cognitive Processing Component 25 via link 17 with the telephone number for the son living in New Jersey. Upon receiving the telephone number for the son living in New Jersey from Knowledge Base 15, Cognitive Processing Component 25 is now able to offer the subscriber with dementia the opportunity to speak to the daughter living in Georgia or the son living in New Jersey or the son living in New York.

In essence, Cognitive Processing Component 25 and User World Model 20 do more than simply assist the subscriber in calling a desired person or a destination. Cognitive Processing Component 25 and User World Model 20 provide alternative contacts from the subscriber's profile to assist the subscriber in making a decision about the appropriate contact to call based on for example, the called party: relationship, location, date and time (e.g., time, date, day of week, window of time and the like), prior calling history, and rules for contact. In this case, the alternative contacts are other family members with a high likelihood of satisfying the subscriber's desired purpose based on stored rules, the subscriber's previous calling history or a combination thereof.

If the subscriber's profile in User World Model 20 is not populated with any data pertaining to the daughter or the other children, Cognitive Processing Component 25 may send a message to the subscriber in an appropriate contact mode indicating that a record for the contact person does not exist, and may, at the same time, offer an alternative treatment, such as connecting with a care giver.

Cognitive Processing Component 25 provides an output to Planning Component 30 that includes information for an establishment of the necessary connections. Planning Component 30 may also include information concerning the presentation interfacing with the user. The presentation will provide for interaction with the user that is simplified based on the user's capabilities and desires. Thus, Cognitive Processing Component 25 has a role in the information assembly as well as customization of the delivered response.

Planning Component 30 builds a plan of action based on the results of Cognitive Processing Component 25. Planning Component 30 takes into account the goals and priorities of the subscriber and monitors the integrity of the commitment. Illustratively, Cognitive Processing Component 25 may signal Planning Component 30 via link 29, based on the request from the subscriber with dementia in New Jersey to speak to the daughter who lives in Georgia, to offer the subscriber the opportunity to speak to the daughter living in Georgia or a son living in New Jersey or another son living in New York. Planning Component 30 may prioritize the offer in a list based on rules provided by Goals/Priority Component 35 to offer, for example, the son from New Jersey as the first choice of finalized called party destination, offer the son from New York as the second choice of finalized called party destination, and offer the daughter from Georgia as the final choice of finalized called party destination. Planning Component 30 may send the offer to the subscriber in a contact mode as prescribed in the subscriber profile, e.g., text, e-mail, voice calls, pictures and other contextual information based on the subscriber's cognitive limitations. Although shown as a stand-alone entity, Planning Component 30 may be implemented as a sub-component of Cognitive Processing Component 25.

Upon receipt of the offer, the subscriber's communication device may prompt the subscriber to select one of the offered destinations from the prioritized list. In this context, “select” may include pressing keys on a handset of the communications device, providing a voice response, touching a screen/image on the communications device, choosing an item from a menu shown on the communications device or inputting information on a screen of the communications device such that a processor, not shown, in the communication device may react to the instruction. Upon receipt of a decision from the subscriber, Planning Component 30 may store the decision and provide an output to Commitment Drivers Component 40 with the desired choice. Alternatively, the subscriber selection may be accomplished automatically by Planning Component 30 based on rules of contact and prioritization detailed in User World Model 20 without subscriber intervention.

Goals/Priority Component 35 may be a subset of User World Model 20, and provides a set of rules for prioritizing data from User World Model 20. These rules are used by Planning Component 30. Illustratively, the profile of the subscriber with dementia in New Jersey may indicate that calls to children should be made to the geographically closest child first. Also illustratively, the profile of the subscriber with dementia in New Jersey may indicate that calls to the children should be made to a particular child based on the time of day or day of the week.

Commitment Drivers Component 40 provides protocol translations between the elements of Knowledge Plane 10 and Control Plane 50. Commitment Drivers Component 40 receives an input from Planning Component 30 to signal Control Plane 50 to establish the session between the call originator and the selected terminating point.

Cognitive Processing Component 25, Planning Component 30 and Commitment Drivers Component 40 may be embodied in one or more server apparatus, but may reside in one or more computing apparatus such as one or more mainframe computers or one or more soft switches or one or more processors or any combination of processors or computers configured to perform the functions described. In the exemplary embodiment, software running on Cognitive Processing Component 25, Planning Component 30 and Commitment Drivers Component 40 facilitates the overall functionality of Cognitive Processing Component 25, Planning Component 30 and Commitment Drivers Component 40. Cognitive Processing Component 25, Planning Component 30 and Commitment Drivers Component 40 may also be embodied in a subscriber communications device, for example a cellular telephone.

Advantageously, the methods according to the invention enable subscribers with cognitive limitations to communicate via telecommunication devices without the assistance of address books or human intervention. Also advantageously, the exemplary embodiments provide a technique for determining alternative contacts to assist the subscriber, for example a subscriber with cognitive limitations, in making an enhanced decision concerning the best person to satisfy the subscriber's desired purpose. Further advantageously, a subscriber with cognitive limitations may request those with whom they would like to talk to by name or image rather than by a telephone number.

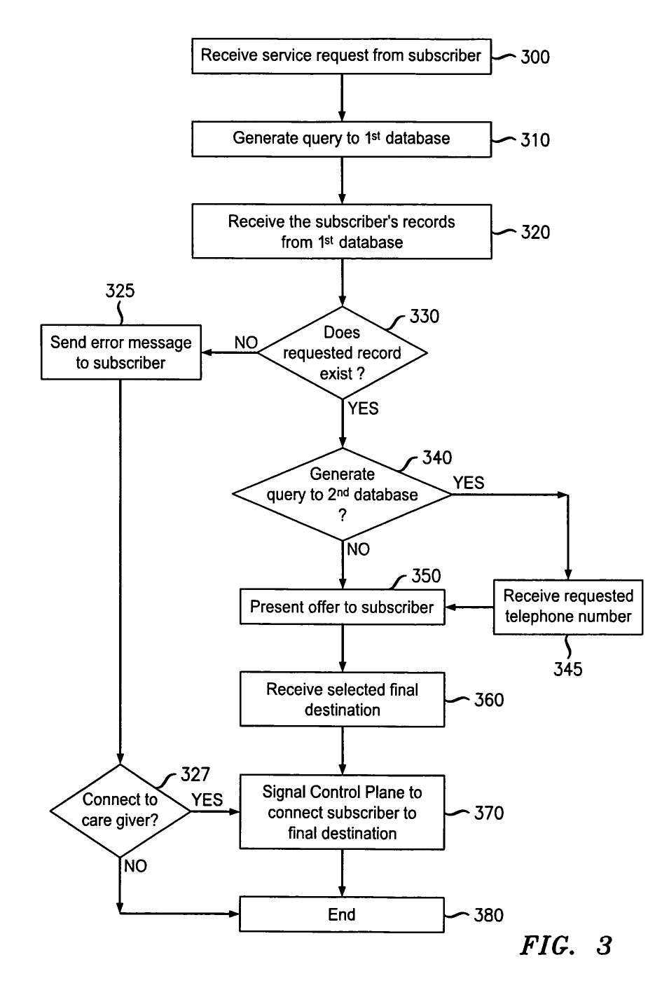

FIG. 3 shows an illustrative flow chart for an exemplary method of operating an embodiment of the invention arranged in accordance with the principles of the invention. The process is entered in step 300 (FIG. 3) when a service request (FIG. 1) to call a specific person or destination is received by Cognitive Processing Component 25 from a subscriber with cognitive limitations. The service request may be received as a voice call, an e-mail message, an instant message, a text message, an image and other contextual information.

In step 310 (FIG. 3), Cognitive Processing Component 25 (FIG. 1) sends a query message to User World Model 20 to retrieve all of the records of the subscriber located in a subscriber profile, e.g., Profile 200 (FIG. 2). Cognitive Processing Component 25 (FIG. 1) may use the subscriber's telephone number as an identifier of Profile 200 (FIG. 2) in the query message.

In step 320 (FIG. 3), Cognitive Processing Component 25 (FIG. 1) receives all of the subscriber's records from User World Model 20.

In step 330 (FIG. 3), it is determined whether the received records from the subscriber's profile (FIG. 2) contain the requested telephone number.

If the test result in conditional branch point 320 (FIG. 3) is NO, indicating that the received records do not contain the requested record, then control is passed to step 325. In step 325 (FIG. 3), Cognitive Processing Component 25 (FIG. 1) sends an error treatment to the subscriber. Sending an error message is optional. Then control is passed to step 327.

If the test result in step 320 (FIG. 3) is YES, indicating that the received records do contain the requested record, Cognitive Processing Component 25 (FIG. 1) retrieves the telephone number of the requested called party, e.g., person or destination, using a name or an image of the requested person or destination. Also, Cognitive Processing Component 25 determines alternative contact telephone numbers and/or other contact identifying information from the retrieved records that have a high likelihood of satisfying the subscriber's desired purpose. Cognitive Processing Component 25 may select the alternative contact telephone numbers and/or other contact identifying information based on stored relationship information, location information, rules of contact, the subscriber's previous calling history, etc., or any combination thereof. Then control is passed to step 340.

In step 340 (FIG. 3), Cognitive Processing Component 25 (FIG. 1) determines whether additional information, e.g., a telephone number, is required based on the other contact identifying data, e.g., a name and address, received from User World Model 20.

If the test result in conditional branch point 340 (FIG. 3) is NO, indicating that Cognitive Processing Component 25 (FIG. 1) does not require additional information, then control is passed to step 350 (FIG. 3). If the test result in step 340 is YES, indicating that Cognitive Processing Component 25 (FIG. 1) does require additional information, then control is passed to step 345.

In step 345 (FIG. 3), Cognitive Processing Component 25 (FIG. 1) sends a query message to Knowledge Base 15 requesting a telephone number based on the additional contact identifying information received from User World Model 20. Knowledge Base 15 receives the query message from Cognitive Processing Component 25, may access an external database, e.g., electronic White or Yellow Pages database, and responds to Cognitive Processing Component 25 with the telephone number.

In step 350 (FIG. 3), Cognitive Processing Component 25 (FIG. 1) forwards the requested telephone number and the alternative telephone numbers to Planning Component 30. Planning Component 30 prioritizes the telephone numbers and the names of the associated parties based on rules from Goals/Priority Component 35, and presents a prioritized list to the subscriber in the subscriber's desired contact mode.

In step 360 (FIG. 3), Cognitive Processing Component 25 (FIG. 1) receives and stores a final called party destination selected by the subscriber. In one embodiment, it is not necessary that the subscriber be queried to select a final called party, e.g., person or destination, as Cognitive Processing Component 25 can automatically make the selection for the subscriber by choosing the highest priority called party.

In step 370 (FIG. 3), Cognitive Processing Component 25 (FIG. 1) forwards the final called party destination to Planning Component 30 which signals Commitment Drivers Component 40 to signal Control Plane 50 to connect the subscriber to the selected final destination.

In step 327 (FIG. 3), it is determined whether the subscriber would like to connect to a care giver.

If the test result in step 327 (FIG. 3) is YES, indicating that the subscriber would like to connect to a care giver, then control is passed to step 370. If the test result in step 327 (FIG. 3) is NO, indicating that the subscriber would not like to connect to a care giver, then control is passed to step 380. In one embodiment, it is not necessary that the subscriber be queried whether they wish to connect to the caregiver, as the subscriber can be automatically connected to the caregiver without further subscriber intervention in this instance.

The process is exited in step 380.

One embodiment of an exemplary architecture described hereinabove includes an architecture in which the data, algorithms, processor, etc., of Knowledge Plane 10 are centralized in a Service Provider's network. In another illustrative embodiment, not shown, the data, algorithms, processor, etc., of Knowledge Plane 10 may be distributed throughout a Service Provider's network.

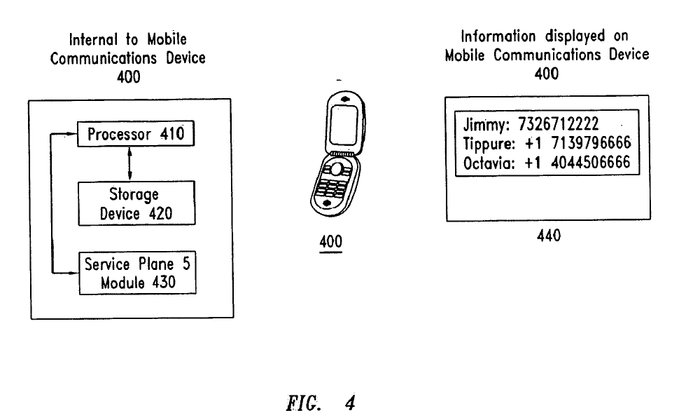

FIG. 4 shows an illustrative embodiment for a mobile communications device arranged in accordance with the principles of the invention. In this embodiment, the data, algorithms, processor, etc., of Knowledge Plane 10 may be located in a handset of a subscriber, in addition to the Service Plane 5. As shown in FIG. 4, mobile communications device 400 comprises Processor 410 which connects to Storage Device 420 and to a Service Plane 5 Module 430 that performs the functions of Service Plane 5 in mobile communication devices, e.g., transmitting, receiving and processing radio frequency (RF) signals.

The user interface of mobile communications device 400 may include an audio interface, such as a microphone and speakers, a visual interface, e.g., Display 440, a user input interface, e.g., a keyboard or touch pad, a pointing device, e.g., a navigation key set, or some combination thereof. An antenna of mobile communications device 400 facilitates the transmission and reception of RF signals.

Processor 410 receives and processes instructional information to perform functions substantially similar to those of Cognitive Processing Component 25. More specifically, Processor 410 retrieves, upon receipt of a request to communicate with a called party, a stored telephone number of the called party by matching a name, an image or an identifier in the request to at least one record and determining one or more alternative telephone numbers that satisfy the request. The record of the called party may be stored in a subscriber profile, e.g., Profile 200, in Storage Device 420. The stored record in the profile relates the called party to rules for contact of the called party. Thus, Storage Device 420 performs functions substantially similar to those of User World Model 20. Furthermore, Processor 410 may generate a prioritized list of the telephone number and the one or more alternative telephone numbers, similar to Planning Component 30, and display the prioritized list on Display 440 for the subscriber. In one embodiment, the prioritized list may be presented audibly, for example, spoken as “1: Jimmy; 2: Tippure; 3: Octavia”. Upon selecting one of the displayed telephone numbers from the prioritized list, mobile communications device 400 may dial the telephone number to connect the subscriber to a final called party determined for the subscriber.

Processor 410 may be any type of processor capable of manipulating data and performing the functions described herein. Processor 410 should not be construed to refer exclusively to hardware capable of executing software, and may implicitly include, without limitation, digital signal processor (DSP) hardware, application specific integrated circuit (ASIC), field programmable gate array (FPGA), read only memory (ROM) for storing software, random access memory (RAM), and non volatile storage. The functions of processor 410 may be provided by a single dedicated processor, by a single shared processor, or by a plurality of individual processors, some of which may be shared.

Those skilled in the art will recognize that the aforementioned communication channels, i.e., links, may encompass optical links, wireless links, packet switched channels, direct communication channels, and any combination thereof. In a mobile communications handset embodiment, links are hardwired.

A person of skill in the art would readily recognize that steps of various above-described methods can be performed by programmed computers. Herein, some embodiments are intended to cover program storage devices, e.g., digital data storage media, which are machine or computer-readable and encode machine-executable or computer-executable programs of instructions where said instructions perform some or all of the steps of methods described herein. The program storage devices may be digital memories, magnetic storage media such as magnetic disks or tapes, hard drives, or optically readable digital data storage media. The embodiments are also intended to cover computers programmed to perform said steps of methods described herein.

The steps or operations described herein are intended as examples. There may be many variations to these steps or operations without departing from the spirit of the invention. For instance, the steps may be performed in a different order, or steps may be added, deleted, or modified.

The present invention may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

The foregoing merely illustrates the embodiments of the invention. It will thus be appreciated that those skilled in the art will be able to devise various arrangements, which, although not explicitly described or shown herein, embody the principles of the invention, and are included within its spirit and scope.

What is claimed:

1. A method of communication, the method comprising:
receiving at a network device a request from a subscriber to connect to a called party;
generating at the network device, in response to the request, a first query to a first database to retrieve at least one record of the subscriber, the at least one record stored in a profile which relates the called party to rules for contact of the called party; and
transmitting at least one signal to facilitate a connection of the subscriber to a final called party determined for the subscriber.

2. The method of claim 1 wherein the profile comprises a name or an image of the called party, a telephone number of the called party, and the rules for contact of the called party.

3. The method of claim 1 wherein the first query is based on an E.164 number as an identifier of the subscriber.

4. The method of claim 1 further comprising:
retrieving, upon receipt of a response to the first query, a telephone number of the called party by matching a name, an image or an identifier in the request to the at least one record; and
determining one or more alternative telephone numbers and/or contact identifying information for contacts in the profile that satisfy the request associated with the called party based on the rules for contact of the called party.

5. The method of claim 4 further comprising generating a second query to a second database to obtain one or more additional telephone numbers related to the contact identifying information.

6. The method of claim 4 further comprising prioritizing the telephone number and the one or more alternative telephone numbers based on the rules for contact.

7. The method of claim 6 further comprising generating a signal to present a prioritized list of the telephone number and the one or more alternative telephone numbers to the subscriber based on the rules for contact.

8. The method of claim 7 further comprising storing as the final called party, upon receipt from the subscriber, the telephone number or one of the one or more alternative telephone numbers.

9. The method of claim 4 wherein the rules for contact for determining one or more alternative telephone numbers are a function of one or more of relationship, familial relation, business relation, geographic location, time, date, prior calling history or a combination thereof of the called party to the subscriber.

10. The method of claim 1 wherein the request is selected from the group consisting of a voice call, an e-mail message, an instant message, a text message, an image, and an electronic signal.

11. An apparatus, comprising:
means for receiving at a network device a request from a subscriber to connect to a called party;
means for generating at the network device, in response to the request, a first query to a first database to retrieve at least one record of the subscriber, the at least one record stored in a profile which relates the called party to rules for contact of the called party; and
means for transmitting at least one signal to facilitate a connection of the subscriber to a final called party determined for the subscriber.

12. The apparatus of claim 11 wherein the profile comprises a name or an image of the called party, a telephone number of the called party, and the rules for contact of the called party.

13. The apparatus of claim 11 further comprising:
means for retrieving, upon receipt of a response to the first query, a telephone number of the called party by matching a name, an image or an identifier in the request to the at least one record; and
means for determining one or more alternative telephone numbers and/or contact identifying information for contacts in the profile that satisfy the request based on the rules for contact of the called party.

14. The apparatus of claim 13 further comprising means for generating a second query to a second database to obtain one or more additional telephone numbers related to the contact identifying information when needed.

15. The apparatus of claim 13 further comprising means for prioritizing the telephone number and the one or more alternative telephone numbers based on a set of stored rules.

16. The apparatus of claim 15 further comprising means for generating a signal to present a prioritized list of the telephone number and the one or more alternative telephone numbers to the subscriber based on the rules for contact.

17. The apparatus of claim 16 further comprising means for storing as the final called party, upon receipt from the subscriber, the telephone number or one of the one or more alternative telephone numbers.

18. A computer-readable storage medium having computer executable instructions for performing steps, comprising:
means for receiving at a network device a request from a subscriber to connect to a called party;
means for generating at the network device, in response to the request, a first query to a first database to retrieve at least one record of the subscriber, the at least one record stored in a profile which relates the called party to rules for contact of the called party; and
means for transmitting at least one signal to facilitate a connection of the subscriber to a final called party determined for the subscriber.

19. A mobile communications device, comprising:
a processor; and
a storage device connected to the processor, the storage device being operable to store at least one record for parties callable by the mobile communications device, the records stored in a profile which relates a callable party to corresponding rules for contact of the callable party;
wherein the processor is operable to retrieve, upon receipt of a request to communicate with a first party, a telephone number for one or more callable parties from the storage device by determining whether a match exists in a first record for a name, an image or an identifier in the request and determining one or more alternative telephone numbers that satisfy the request based on the corresponding rules for contact of the first party.

20. A method of operating a mobile communications device, the method comprising:
receiving a request to communicate with a first party;
retrieving, a telephone number for a callable party stored in the mobile communications device by matching a name, an image or an identifier in the request to a record associated with the callable party;
determining one or more alternative callable parties that satisfy the request based on contact rules associated with the callable party; and
providing a prioritized list of the called party and the one or more alternative callable parties on the mobile communications device.
